(19) United States
(12) Patent Application Publication
(10) Pub. No.: US 2014/0116932 A1
(43) Pub. Date: May 1, 2014

(54) Novel Liquid Chromatographic Media and Methods of Synthesizing the Same

(71) Applicants: GUANGQING LI, FOOTHILL RANCH, CA (US); THE FOURTH MILITARY MEDICAL UNIVERSITY OF CHINESE PLA, XI'AN (CN)

(72) Inventors: Aidong Wen, Xi'an (CN); Xiaoli Sun, Xi'an (CN); Guangqing Li, Foothill Ranch, CA (US); Haibo Wang, Xi'an (CN); Yanyan Jia, Xi'an (CN)

(21) Appl. No.: 14/058,970

(22) Filed: Oct. 21, 2013

(30) Foreign Application Priority Data
Oct. 25, 2012 (CN) 201210412474.8

(51) Int. Cl. B01J 20/291; B01J 20/281; B01D 15/32

(52) U.S. Cl. CPC B01J 20/291; B01D 15/327; G01N 30/48
USPC 210/198.2; 502/401; 556/419

(57) ABSTRACT

The present invention provides a bisamide-containing novel liquid chromatographic media and method of synthesizing the same. A novel polar bisamide functional group, which can form hydrogen bonds or ion pairs with residual silanols on the surface of silica gel, is used as the bonded phase on the surface of silica gel to better shield the activity of silanols and to eliminate the influence of residual silanol groups. Compared with conventional C18 columns, these novel bonded phases have different selectivity; they can work not only in 0 to 100% water but also in 0 to 100% organic mobile phase. In particular, they exhibit good peak shapes and resolutions for polar and basic compounds and have good stability within a very wide pH range. These properties make the new stationary phases a useful complement to conventional C18 columns for a variety of HPLC applications.

### CROSS-REFERENCE TO RELATED APPLICATIONS

This application claims priority from CN Application No. 201210412474.8, filed Oct. 25, 2012, which is incorporated herein by reference in its entirety.

### FIELD OF THE INVENTION

The present invention belongs to the field of preparation technique of separation materials for liquid chromatography, and relates to liquid chromatographic media and a method of preparing the same. The liquid chromatographic media are suitable for separation of polar and basic compounds, and are used for separation and purification of a multicomponent mixture in industries such as organic synthesis, food, environment, pharmaceuticals, etc.

### BACKGROUND OF THE INVENTION

High performance liquid chromatography (HPLC) is an efficient and fast technique for separation and analysis developed in the 1970s, and has become the most commonly used means of separation and analysis in various fields such as chemistry and chemical engineering, life sciences, biotechnology, food hygiene, drug detection, and environmental monitoring. Chromatographic analysis and separation are based on the difference between interactions of the solute to be analyzed with the mobile phase and the stationary phase to achieve separation of various components in a mixture. The performance of a stationary phase with high selectivity is key for the separation and analysis, and is the basis for establishment and development of various HPLC separation modes. In various chromatographic stationary phases, the stationary phases using silica gel as support play an irreplaceable role. This is because in addition to the fact that silica gel has good mechanical strength, easily controlled pore structure and specific surface area, and better chemical stability and thermostability, silica gel further contains silanol groups on its surface, which can be chemically modified to obtain various functional stationary phases. Reversed-phase liquid chromatography (RPLC) is a very widely applied technique for separation and analysis. Due to its advantages of high column efficiency, good reproducibility, high separation efficiency, good compatibility with MS detector, etc., most of applications at present are realized by employing reversed-phase liquid chromatography. Alkyl-bonded silica gel stationary phase is the main media employed in the analytical method of RPLC. However, during preparation of the media for reversed-phase liquid chromatography, due to the steric hindrance, it is impossible for the silanol groups on the surface of silica gel to react with a silane reagent completely. In separation of some polar and basic compounds, the residual silanol groups result in severe tailing, deformed chromatographic peaks, and reduced column efficiency. The endcapping reaction generally involves performing a repeated silylation reaction with a silylating reagent that has a short-chain alkyl in order to remove unreacted silanol groups. However, the endcapping reaction cannot completely eliminate the influence of the residual silanol groups. In order to improve the chromatographic separation and analysis of basic compounds, much attention has been focused on novel chromatographic media containing polar groups which shield the effects of unreacted silanol groups.

Kirkland et al. prepared C18 monodentate (J. Chromatogr. Sci. 1994, 32, 473) and bidentate (Anal. Chem. 1998, 70, 4344) silane-bonded stationary phases containing isopropyl or isobutyl in the side chain. Because the steric effect of the side chain blocks the attack of other groups to the residual silanol groups, this media has good column efficiency in the separation of basic compounds at pH 7, with a symmetric chromatographic peak shape. Buszewski et al. (J. Chromatogr. A 1994, 673, 11) prepared an amide type charge-shielding bonded stationary phase for separation of basic compounds. However, the two-step synthetic method has a poor reproducibility and the unreacted amino groups are susceptible to ion exchange with analytes, leading to tailing of chromatographic peaks.

With the rapid development of research fields such as proteomics, metabolomics, and modernization of Chinese Traditional Medicine, substances with strong polarity and hydrophilicity have rapidly become important research objects in the fields of analytical chemistry and biochemistry. However, such substances are often difficult to be effectively separated by liquid chromatography. In analysis and purification of drugs, analysis of metabolites, analysis of food and environment, and analysis of pesticide residues, the chromatographic analysis of polar compounds is also a challenge in the field of analytical testing. For organic acids or organic bases which are easily ionized, ion pair reagents are generally added into the mobile phase to achieve the purpose of separation. However, such methods have many distinct disadvantages; for example, the system is complicated, the reproducibility of the method is poor, the equilibrium time is long, and it is very difficult to apply LC-MS, etc. These issues have spurred the development of reversed-phase columns which can match with 100% aqueous mobile phase and normal-phase columns which can match with highly aqueous mobile phase, to expand the application scopes of normal-phase and reversed-phase chromatographic columns. In this way, compounds with hydrophilicity and strong polarity can be analyzed by liquid chromatography without using ion pair reagents. However, both of the two types of chromatographic columns have disadvantages such as poor stability and reproducibility, difficulty in separation of polar and basic compounds, and complicated separation mechanisms.

### SUMMARY OF THE INVENTION

In view of the above deficiencies, the present invention provides a novel bisamide-containing polar stationary phase for liquid chromatography and a method of synthesizing the same.

According to one aspect of the present invention, there is provided a bisamide-containing liquid chromatographic media, comprising silica gel substrate which is modified on the surface by at least a polar silane having two amide linkages and further treated with an endcapping silane reagent, and having a general formula of

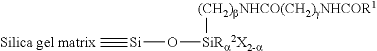

wherein R¹ is substituted or unsubstituted C₁-C₂₀ alkyl, phenyl, aralkyl, cycloalkyl, or heterocycloalkyl;

R² is substituted or unsubstituted C₁-C₈ alkyl, phenyl, aralkyl, cycloalkyl, or heterocycloalkyl;

α is 0 or 1;

β is an integer of 1 to 10;

γ is an integer of 1 to 20; and

X is halogen, alkoxy, acyloxy, or amino

In a preferred embodiment of the present invention, R¹ can be substituted or unsubstituted C₁-C₂₀ alkyl, and R² can be substituted or unsubstituted C₁-C₈ alkyl or phenyl.

In an embodiment of the present invention, β can be 1, 2, 3, 4, 5, 6, 7, 8, 9, or 10.

In a preferred embodiment of the present invention, β can be an integer of 1 to 7. In a more preferred embodiment of the present invention, β can be an integer of 1 to 5. In a still more preferred embodiment of the present invention, β can be 3.

In an embodiment of the present invention, γ can be 1, 2, 3, 4, 5, 6, 7, 8, 9, 10, 11, 12, 13, 14, 15, 16, 17, 18, 19, or 20.

In a preferred embodiment of the present invention, γ can be an integer of 1 to 10. In a more preferred embodiment of the present invention, γ can be an integer of 1 to 6. In a still more preferred embodiment of the present invention, γ can be 1.

According to another aspect of the present invention, there is provided a polar packing media having two amide linkages, which has a general formula of:

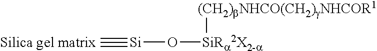

wherein R¹ is substituted or unsubstituted C₁-C₂₀ alkyl, phenyl, aralkyl, cycloalkyl, or heterocycloalkyl;

R² is substituted or unsubstituted C₁-C₈ alkyl, phenyl, aralkyl, cycloalkyl, or heterocycloalkyl;

α is 0 or 1;

β is an integer of 1 to 10;

γ is an integer of 1 to 20; and

X is halogen, alkoxy, acyloxy, or amino

In an embodiment of the present invention, β can be 1, 2, 3, 4, 5, 6, 7, 8, 9, or 10.

In a preferred embodiment of the present invention, β can be an integer of 1 to 7. In a more preferred embodiment of the present invention, β can be an integer of 1 to 5. In a still more preferred embodiment of the present invention, β can be 3.

In an embodiment of the present invention, γ can be 1, 2, 3, 4, 5, 6, 7, 8, 9, 10, 11, 12, 13, 14, 15, 16, 17, 18, 19, or 20.

In a preferred embodiment of the present invention, γ can be an integer of 1 to 10. In a more preferred embodiment of the present invention, γ can be an integer of 1 to 6. In a still more preferred embodiment of the present invention, γ can be 1.

According to another aspect of the present invention, there is provided a method of preparing the bisamide-containing liquid chromatographic media, comprising the steps of:

(a) modifying the surface of the silica gel substrate with a polar silane having two amide linkages;

(b) hydrolyzing and drying the thus-obtained materials; and

(c) further modifying the above prepared dry silica gel media with an endcapping silane reagent.

In some embodiments, the above method further comprises, before step (a), pre-treating the silica gel substrate with a strong acid. The strong acid that can be used includes, but is not limited to, concentrated hydrochloride acid, concentrated sulfuric acid, concentrated nitric acid, and the like. Preferably, concentrated hydrochloride acid is used.

In a preferred embodiment of the present invention, the silica gel substrate are spherical porous silica gel, and its particle size can be 1 μm to 60 μm, the pore size can be 50 Å to 1000 Å, and the specific surface area can be 50 m²/g to 500 m²/g.

In a preferred embodiment of the present invention, the polar silane having two amide linkages used for treating the silica gel substrate is prepared by reacting an acylated amino acid with an aminosilane in the presence of a condensing agent, and has the general formula of

R¹CONH(CH₂)_{γ}CONH(CH₂)_{β}SiR²_{α}X_{3-α}

wherein R¹ is substituted or unsubstituted C₁-C₂₀ alkyl, phenyl, aralkyl, cycloalkyl, or heterocycloalkyl;

R² is substituted or unsubstituted C₁-C₈ alkyl, phenyl, aralkyl, cycloalkyl, or heterocycloalkyl;

α is 0, 1, or 2;

β is an integer of 1 to 10;

γ is an integer of 1 to 20; and

X is halogen, alkoxy, acyloxy, or amino

In an embodiment of the present invention, β can be 1, 2, 3, 4, 5, 6, 7, 8, 9, or 10.

In a preferred embodiment of the present invention, β can be an integer of 1 to 7. In a more preferred embodiment of the present invention, β can be an integer of 1 to 5. In a still more preferred embodiment of the present invention, β can be 3.

In an embodiment of the present invention, γ can be 1, 2, 3, 4, 5, 6, 7, 8, 9, 10, 11, 12, 13, 14, 15, 16, 17, 18, 19, or 20.

In a preferred embodiment of the present invention, γ can be an integer of 1 to 10. In a more preferred embodiment of the present invention, γ can be an integer of 1 to 6. In a still more preferred embodiment of the present invention, γ can be 1.

In a preferred embodiment of the present invention, the endcapping silane reagent can be a conventional the endcapping reagent. For example, the endcapping reagent which can be used in the present invention is one or more selected from the group consisting of monosilane, disilane, trisilane, tetrasilane, and pentasilane.

Examples of monosilane which can be used in the present invention include, but are not limited to, trimethylchlorosilane, N,N-dimethyltrimethylsilylamine, trimethylsilylimidazole, methyltrichlorosilane, dimethyldichlorosilane, dimethoxydimethylsilane, trimethylsilanol, and N-trimethylsilylacetamide.

Examples of disilane which can be used in the present invention include, but are not limited to, hexamethyldisilazane and 1,3-dimethoxytetramethyldisiloxane.

Examples of trisilane which can be used in the present invention include, but are not limited to, hexamethylcyclotrisiloxane.

Examples of tetrasilane which can be used in the present invention include, but are not limited to, octamethylcyclotetrasiloxane.

Examples of pentasilane which can be used in the present invention include, but are not limited to, decamethylcyclopentasiloxane.

According to another aspect of the present invention, there is provided a chromatographic column packed with the above bisamide-containing packing media.

In a preferred embodiment of the present invention, under acidic and basic conditions, the relative standard deviations of retention time, retention factor and asymmetry or peak asymmetry of the analyte are all less than 5%.

The bisamide-containing polar liquid chromatographic media can meet such requirements to achieve the separation and analysis of the majority of organic compounds including polar and basic compounds under simple chromatographic conditions, and can effectively improve the chromatographic peak shape of basic compounds and the ability to work under highly aqueous mobile phase conditions. These new chromatographic stationary phases have novel structures, and can form hydrogen bonds or ion pairs with the residual silanol groups on the surface of silica gel to better shield the activity of silanols and eliminate the influence of residual silanol groups. In comparison with conventional C18 columns, these new chromatographic stationary phases have better selectivity and resolution, higher column efficiency, and a broader application scope. These new chromatographic stationary phases can also form hydrogen bonds with organic compounds containing oxygen, nitrogen, phosphorus, and sulfur, and thus have very good application potential.

The chromatographic column of the present invention can be used in separation of normal phase, reversed-phase, and hydrophilic interaction chromatography (HILIC), and is suitable for isocratic or gradient analysis; that is, the component proportion of the mobile phase can stay constant or change according to certain rules during the whole separation process. The mobile phase can contain 0 to 100% water or 0 to 100% organic solvent. When water is present, other ingredients should be miscible with water. The organic solvents commonly used include, but are not limited to, methanol, acetonitrile, isopropanol, ethanol, tetrahydrofuran, etc. 0 to 100 mmol/L soluble acid, base, or other buffer salt can be added into the mobile phase. The pH range of the mobile phase is between pH 2 to 8 to ensure certain stability of chromatographic column. The temperature scope can be 5 to 60° C., preferably 20 to 40° C. When using a LC-MS, application of high organic mobile phase can enhance the process of ionization and thereby increase the sensitivity of detection.

### Embodiments

The present invention employs silica gel particles as support. The surface of the silica gel particles is modified with a polar silane having two amide linkages to obtain bonded silica gel media. The latter is hydrolyzed and further modified with an endcapping reagent to obtain the novel liquid chromatographic media with high stability. Functioning as a stationary phase, the liquid chromatographic media of the present invention has characteristics of simple synthesis and good separation performance.

The key of the present invention is to employ a functional group of novel polar bisamide as the bonded phase on the surface of silica gel, so as to bring about better selectivity and resolution than a conventional C₁₈ chromatographic column or a chromatographic column containing one amide does. The present invention is characterized in that the functional group of polar bisamide has not only dipole-dipole interaction, but also hydrophobic interaction and various other action mechanisms, and therefore can effectively separate and detect acidic, neutral and basic compounds simultaneously. Particularly, the liquid chromatographic media of the present invention have very strong ability to separate polar and basic compounds, and can form hydrogen bonds with organic compounds containing oxygen, nitrogen, phosphorus or sulfur and thus have very good application potential.

As used herein, the term “alkyl” refers to a saturated, branched or unbranched hydrocarbyl, and includes, but is not limited to, methyl, ethyl, propyl, iso-propyl, butyl, iso-butyl, tert-butyl, n-pentyl, n-hexyl, n-heptyl, n-octyl, n-nonyl, n-decyl, undecyl, lauryl, palmityl, and stearyl.

As used herein, the term “aralkyl” refers to an alkyl substituted with aryl, wherein the alkyl is as defined above. “Aryl” refers to an aromatic carbon ring group having monocyclic (e.g., phenyl), multiple (e.g., biphenyl), or fused aromatic rings in which at least one ring is aromatic (e.g., 1,2,3,4-tetralyl or naphthyl).

As used herein, the term “cycloalkyl” refers to a saturated aliphatic mono- or polycyclic system comprising 3 to 20 carbon atoms, preferably 3 to 8 carbon atoms.

As used herein, the term “heterocycloalkyl” refers to a cycloalkyl as defined above in which one or more carbon atoms in the ring is/are substituted with heteroatom(s) selected from the group consisting of O, N, and S.

As used herein, the term “halogen” refers to chlorine, bromine, fluorine, or iodine.

As used herein, the term “alkoxy” refers to —O alkyl, wherein the alkyl is as defined above.

As used herein, the term “acyloxy” refers to —OCO alkyl, wherein the alkyl is as defined above.

As used herein, the terms “asymmetry” or “peak asymmetry” refer to a factor describing the shapes of chromatographic peaks, defined as the ratio of the distance between the peak apex and the back side of the chromatographic curve and the front side of the curve at 10% peak height.

As used herein, the terms “retention factor” refer to a measure of the strength of the interaction of the sample with the packing material and is defined by the expression k=(t_{R}−t₀)/t₀, where t_{R} is the retention time of the measured peak, and t₀ is retention time of the non-retained component.

When a group is substituted, the substituent can be, for example, alkyl, alkoxy, hydroxyl, amino, halogen, carboxyl, cyano, mercapto, sulfuryl, sulfoxide, sulfonic acid group, keto group, aldehyde group, nitro, or nitroso.

The silica gel substrate employed in the present invention are spherical porous silica gel, the pore size can be 50 Å to 1000 Å, preferably 100 Å to 300 Å, the particle size is 1 μm to 60 μm, preferably 1.5 μm to 20 μm, and the specific surface area is 50 m²/g to 500 m²/g, preferably 300 m²/g to 450 m²/g.

The polar silane reagent having two amide linkages used for treating the silica gel substrate can be prepared as follows: firstly, preparing a carboxylic acid containing an amide linkage, then reacting the resultant carboxylic acid with an aminosilane to form the second amide linkage. The polar silane reagent preferably has a formula of R¹—CONH(CH₂)_{γ}CONH(CH₂)_{β}SiR²_{α}X_{3-α}, wherein R¹ is substituted or unsubstituted C₁-C₂₀ alkyl, phenyl, aralkyl, cycloalkyl, or heterocycloalkyl; R² is substituted or unsubstituted C₁-C₈ alkyl, phenyl, aralkyl, cycloalkyl, or heterocycloalkyl; α is 0, 1, or 2; β is an integer of 1 to 10; preferably an integer of 1 to 7, more preferably an integer of 1 to 5, still more preferably 3; γ is an integer of 1 to 20, preferably an integer of 1 to 10, more preferably an integer of 1 to 6, still more preferably 1; and X is halogen, alkoxy, acyloxy, or amino

The endcapping reagent is one or more selected from the group consisting of monosilane, disilane, trisilane, tetrasilane, and pentasilane.

In one embodiment, monosilane can be used as the endcapping-reagent, such as trimethylchlorosilane, N,N-dimethyltrimethylsilylamine, trimethylsilylimidazole, methyltrichlorosilane, dimethyldichlorosilane, dimethoxydimethylsilane, trimethylsilanol, and N-trimethylsilylacetamide.

In one embodiment, disilane can be used as the endcapping reagent, such as hexamethyldisilazane and 1,3-dimethoxytetramethyldisiloxane.

In one embodiment, trisilane can be used as the endcapping reagent, such as hexamethylcyclotrisiloxane.

In one embodiment, tetrasilane can be used as the endcapping reagent, such as octamethylcyclotetrasiloxane.

In one embodiment, pentasilane can be used as the endcapping reagent, such as decamethylcyclopentasiloxane.

In the preparation of the liquid chromatographic media of the present invention, the silica gel is refluxed in concentrated hydrochloric acid for 16 to 24 hours, washed with double-distilled water until neutral, and dried under vacuum at 140 to 170° C. for 8 to 12 hours. A one-step synthetic method is employed to bond the polar silane having two amide linkages onto the silica gel. The molar ratio of the silica gel substrate to the polar silane reagent is 1:3, preferably 1:1.5. The reaction solvent is selected from a group consisting of n-decane, toluene, xylene, diethylbenzene, etc. and a combination thereof, preferably xylene or n-decane. The volume ratio of the silica gel substrate to the solvent is 1:10, preferably 1:5. The catalyst is selected from the group consisting of pyridine, hexahydropyridine, N-alkyl pyridine, triethylamine, imidazole, N,N-dimethylbutylamine, etc. and a combination thereof, preferably pyridine or triethylamine or a combination thereof. The reaction time is 12 to 72 hours, preferably 24 to 48 hours. Preferably, the reaction temperature for performing the modification of the silica gel substrate is the reflux temperature of the inert solvent. The thus-obtained bonded phase is hydrolyzed under an acidic condition at room temperature for 16 to 24 hours, and the acid can be selected from the group consisting of formic acid, acetic acid, trifluoroacetic acid, and phosphoric acid, etc., preferably trifluoroacetic acid. The above prepared dry silica gel media is further modified with an endcapping reagent and the molar ratio of the silica gel media to the endcapping reagent employed is 1:3, preferably 1:1.5. The reaction solvent is selected from the group consisting of n-decane, toluene, xylene, diethylbenzene, etc. and a combination thereof, preferably xylene or n-decane. The volume ratio of the bonded phase to the solvent is 1:10, preferably 1:5. The catalyst is selected from the group consisting of pyridine, hexahydropyridine, N-alkyl pyridine, triethylamine, imidazole, N,N-dimethylbutylamine, etc. and a combination thereof, preferably pyridine or triethylamine or a combination thereof. The reaction time is 12 to 72 hours, preferably 24 to 48 hours. Preferably, the reaction temperature for performing the endcapping reaction is the reflux temperature of the inert solvent or reagent. Finally, a novel liquid chromatographic media having high stability and good chromatographic separation performance is obtained.

### DESCRIPTION OF THE DRAWINGS

FIG. 1 contains the chromatogram for separating thiourea-aniline-phenol-toluidine (o-, m-, p-)-N,N-dimethylaniline-ethyl benzoate-toluene-ethylbenzene by the chromatographic column (stationary phase 4) of the present invention in Example 13. 1 represents thiourea, 2 represents aniline, 3 represents phenol, 4 represents o-, m-, p-toluidine, 5 represents N,N-dimethylaniline, 6 represents ethyl benzoate, 7 represents toluene, and 8 represents ethylbenzene.

FIG. 2 contains the test charts of the stability of the chromatographic column (stationary phase 4) of the present invention in Example 13 at pH 1.5 and pH 11.

FIG. 3 contains the test results for 1000 times consecutive sample injections of ceftazidime-cefadroxil-cefuroxime axetil-cefazolin-cefaclor-cefalexin mixture by the chromatographic column (stationary phase 4) of the present invention in Example 13. 1 represents ceftazidime, 2 represents cefadroxil, 3 represents cefuroxime axetil, 4 represents cefazolin, 5 represents cefaclor, and 6 represents cefalexin.

FIG. 4 contains the chromatogram for separating β-blocker mixture under a high pH condition by the chromatographic column (stationary phase 4) of the present invention in Example 14. 1 represents pindolol, 2 represents metoprolol, 3 represents bisoprolol, 4 represents propranolol, and 5 represents alprenolol.

FIG. 5 contains the chromatogram for separating β-blocker mixture under a low pH condition by the chromatographic column (stationary phase 4) of the present invention in Example 14. 1 represents nadolol, 2 represents pindolol, 3 represents metoprolol, 4 represents labetalol, 5 represents propranolol, and 6 represents alprenolol.

FIG. 6 contains the chromatograms for separating caffeine metabolites by the chromatographic column (stationary phase 2) of the present invention, Waters SymmetryShield RP18 and Agilent Zorbax Bonus-RP in Example 15. 1 represents uric acid, 2 represents xanthine, 3 represents 7-methyl xanthine, 4 represents 1-methyl uric acid, 5 represents 3-methyl xanthine, 6 represents 1,3-dimethyl uric acid, 7 represents theobromine, 8 represents 1,7-dimethyl xanthine, and 9 represents theophylline.

FIG. 7 contains the chromatograms for separating tocopherol isomers by C18 column and the chromatographic column (stationary phase 1) of the present invention in Example 16. 1 represents δ-tocopherol, 2 represents γ-tocopherol, and 3 represents α-tocopherol.

FIG. 8 contains the chromatograms for separating water-soluble vitamins by the chromatographic column (stationary phase 3) of the present invention, Waters SymmetryShield RP18 and Agilent Zorbax Bonus-RP in Example 17. 1 represents L-ascorbic acid, 2 represents orotic acid, 3 represents pyridoxamine, 4 represents pyridoxal, 5 represents pyridoxine, 6 represents nicotinamide, and 7 represents thiamine.

FIG. 9 contains the chromatograms for separating nucleotides by ODS column and the chromatographic column (stationary phase 5) of the present invention in Example 18. 1 represents CTP, 2 represents CMP, 3 represents GTP, 4 represents GDP, 5 represents GMP, 6 represents ATP, 7 represents ADP, and 8 represents AMP.

FIG. 10 contains the chromatograms for separating a mixture of tricyclic antidepressants and benzodiazepines by the chromatographic column (stationary phase 5) of the present invention, Waters SymmetryShield RP18 and Agilent Zorbax Bonus-RP in Example 19. 1 represents nitrazepam, 2 represents nordoxepin, 3 represents alprazolam, 4 represents diazepam, 5 represents oxazepam, 6 represents triazolam, 7 represents nortriptyline, 8 represents clonazepam, and 9 represents trimipramine.

### EXAMPLES

For better understanding of the present invention, the present invention is further illustrated by examples.

### Example 1

### General Method for Preparing a Polar Silane Having Two Amide Linkages

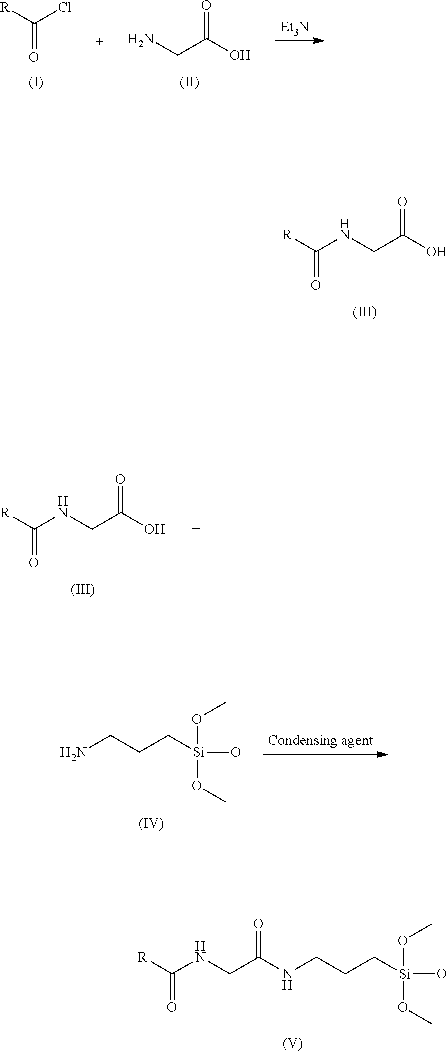

Wherein R is substituted or unsubstituted C₁-C₂₀ alkyl, phenyl, aralkyl, cycloalkyl, or heterocycloalkyl.

CH₂Cl₂ (100 mL), glycine (II) (20 mmol) and triethylamine (5 mL) were added into a three-necked flask. The mixture was vigorously stirred in an ice bath. A solution of compound I (20 mmol) in CH₂C1₂ (20 mL) was added dropwise. The reaction mixture was stirred at room temperature for 2 to 4 hours. The crude product was purified via column chromatography to obtain intermediate product III.

To a three-necked flask were added the intermediate product III (20 mmol), N,N′-dicyclohexylcarbodiimide (22 mmol), 4-dimethylaminopyridine (1.2 mmol) and CH₂Cl₂ (100 mL). 3-Aminopropyltrimethoxysilane (20 mmol) was added under stirring, and the reaction mixture was stirred at room temperature for 3 to 6 hours. After completion of the reaction, the mixture was filtered, the filtrate was washed with sodium carbonate solution, and the organic layer was dried over anhydrous magnesium sulfate. After removing the solvent under reduced pressure, the residue was purified by column chromatography to obtain the target product of polar silane having two amide linkages.

Various polar silanes having two amide linkages were synthesized by employing the same reaction conditions and treating methods as Example 1 through changing the start materials I, II and IV as shown in Table 1. The structures of the products were confirmed by IR, NMR, elemental analysis, etc.

TABLE 1

| Serial Nos. | R¹ | R² | α | β | γ | X |
|---|---|---|---|---|---|---|
| 1 | —CH₃ | —CH₃ | 2 | 3 | 1 | —OC₂H₅ |
| 2 | —C₂H₅ | —C₂H₅ | 2 | 3 | 1 | —NH₂ |
| 3 | —CH(CH₃)₂ | —C₃H₇ | 1 | 3 | 1 | —F |
| 4 | —C₃H₇ | | 0 | 3 | 1 | —OCH₃ |
| 5 | —CH₃ | —C₆H₅ | 1 | 3 | 1 | —OC₂H₅ |
| 6 | —C₇H₁₅ | | 0 | 3 | 1 | —Cl |
| 7 | —C₇H₁₅ | —CH₃ | 2 | 3 | 1 | —OC₂H₅ |
| 8 | —C₉H₁₉ | | 0 | 3 | 1 | —OCH3 |
| 9 | —C₉H₁₉ | —CH₃ | 2 | 3 | 1 | —Cl |
| 10 | —C₁₀H₂₁ | | 0 | 3 | 1 | —Cl |
| 11 | —C₁₀H₂₁ | C₆H₅CH₂— | 1 | 3 | 1 | —OCH₃ |
| 12 | —C₁₁H₂₃ | | 0 | 3 | 1 | —OCH₃ |
| 13 | —C₁₁H₂₃ | —C₂H₅ | 2 | 3 | 1 | —Cl |
| 14 | —C₁₅H₃₁ | | 0 | 3 | 1 | —OCH₃ |
| 15 | —C₁₅H₃₁ | —CH₃ | 2 | 3 | 1 | —Cl |
| 16 | —C₁₀H₂₁ | —CH₃ | 2 | 3 | 2 | —OCH₃ |
| 17 | —C₉H₁₉ | —C₆H₅ | 2 | 5 | 4 | —Cl |
| 18 | —C₉H₁₉ | C₆H₅CH₂CH₂— | 1 | 3 | 4 | —OC₂H₅ |
| 19 | —C₇H₁₅ | | 0 | 7 | 6 | —OCH₃ |
| 20 | —C₇H₁₅ | —CH₃ | 2 | 3 | 6 | —OCH₃ |

In Examples 2 to 6, different compounds I and the same reaction conditions and treating methods as Example 1 were employed to synthesize various polar silanes having two amide linkages.

### Example 2

The starting material is n-octanoyl chloride. Intermediate n-octanoyl glycine: ¹HNMR (500 MHz, CDCl₃) δ, 0.85 (t, 3H), 1.31 (m, 8H), 1.56 (m, 2H), 2.11 (t, 2H), 4.25 (s, 2H), 8.05 (s, 1H). Calc. C % 59.68, H % 9.52, N % 6.96; Found C % 59.62, H % 9.48, N % 6.99. Target product n-octyl bisamide silane: m.p. 50-52° C. ¹HNMR (500 MHz, CDCl₃) δ 0.86 (t, 3H), 0.97 (t, 2H), 1.29 (m, 8H), 1.53 (m, 2H), 1.62 (m, 2H), 2.09 (t, 2H), 3.35 (t, 2H), 4.12 (d, 2H), 8.01 (s, 1H), 8.06 (s, 1H). Calc. C % 41.55, H % 6.71, N % 7.45; Found C % 41.40, H % 6.82, N % 7.55.

### Example 3

The starting material is n-decanoyl chloride. Intermediate n-decanoyl glycine: ¹HNMR (500 MHz, CDCl₃) δ 0.85 (t, 3H), 1.30 (m, 12H), 1.55 (m, 2H), 2.16 (t, 2H), 4.33 (s, 2H), 8.03 (s, 1H). Calc. C % 62.85, H % 10.11, N % 6.11; Found C % 63.02, H % 10.19, N % 6.04. Target product n-decyl bisamide silane: m.p. 55-56° C. ¹HNMR (500 MHz, CDCl₃) δ 0.54 (m, 2H), 0.82 (t, 3H), 1.26 (m, 12H), 1.51 (m, 2H), 1.61 (m, 2H), 2.11 (t, 2H), 3.38 (q, 2H), 3.56 (s, 9H), 4.13 (s, 2H), 8.04 (s, 1H), 8.09 (s, 1H). Calc. C % 55.35, H % 9.81, N % 7.17; Found C % 55.56, H % 9.87, N % 7.03.

### Example 4

The starting material is undecanoyl chloride. Intermediate undecanoyl glycine: ¹HNMR (500 MHz, CDCl₃) δ 0.84 (t, 3H), 1.29 (m, 14H), 1.58 (m, 2H), 2.15 (m, 2H), 4.16 (s, 2H). Calc. C % 64.16, H % 10.36, N % 5.76; Found C % 64.10, H % 10.38, N % 5.71. Target product undecyl bisamide silane: m.p. 58-59° C. ¹HNMR (500 MHz, CDCl₃) δ 0.57 (m, 2H), 0.86 (t, 3H), 1.29 (m, 14H), 1.60 (m, 2H), 2.09 (t, 2H), 3.21 (q, 2H), 3.60 (s, 9H), 4.12 (b, 2H). Calc. C % 56.40, H % 9.96, N % 6.92; Found C % 56.33, H % 9.87, N % 6.98.

### Example 5

The starting material is lauroyl chloride. Intermediate lauroyl glycine: ¹HNMR (500 MHz, CDCl₃) δ 0.88 (t, 3H), 1.25-1.32 (m, 16H), 1.54 (m, 2H), 2.18 (t, 2H), 4.36 (s, 2H), 8.05 (s, 1H). Calc. C % 65.33, H % 10.57, N % 5.44; Found C % 65.25, H % 10.38, N % 5.58. Target product lauryl bisamide silane: m.p. 62-64° C. ¹HNMR (500 MHz, CDCl₃) δ 0.53 (m, 2H), 0.84 (t, 3H), 1.23-1.29 (m, 16H), 1.56 (m, 2H), 1.61 (m, 2H), 2.05 (t, 2H), 3.40 (q, 2H), 3.58 (s, 9H), 4.05 (s, 2H), 8.01 (s, 1H), 8.08 (s, 1H). Calc. C % 57.38, H % 10.11, N % 6.69; Found C % 57.31, H % 10.05, N % 6.74.

### Example 6

The starting material is palmitoyl chloride. Intermediate palmitoyl glycine: ¹HNMR (500 MHz, CDCl₃) δ 0.81 (t, 3H), 1.24-1.34 (m, 24H), 1.52 (m, 2H), 2.18 (t, 2H), 4.49 (s, 2H), 8.10 (s, 1H). Calc. C % 68.97, H % 11.25, N % 4.47; Found C % 68.90, H % 11.17, N % 4.56. Target product palmityl bisamide silane: m.p. 68-70° C. ¹HNMR (500 MHz, CDCl₃) δ 0.52 (m, 2H), 0.85 (t, 3H), 1.25-1.33 (m, 24H), 1.58-1.62 (m, 4H), 2.12 (t, 2H), 3.44 (q, 2H), 3.62 (s, 9H), 4.15 (s, 2H), 8.02 (s, 1H), 8.11 (s, 1H). Calc. C % 60.72, H % 10.62, N % 5.90; Found C % 60.78, H % 10.51, N % 5.78.

### Example 7

### General Method for Preparing Polar Chromatographic Stationary Phase

Into a three-necked flask were added 10 g spherical silica gel (AGC Si-Tech Co. Ltd., 5 μm, 100 Å, 400 m²/g) and concentrated hydrochloric acid (50 mL). The mixture was refluxed at 100° C. for 16 to 24 hours, then cooled to room temperature and filtered. The filter cake was washed with double-distilled water until neutral, and then the silica gel was dried under vacuum at 140° C. for 8 hours.

The silica gel was cooled and placed in a reactor. Xylene (100 mL) and excess by 50% molar of silane and pyridine were added. The mixture was mechanically stirred and heated to reflux under argon atmosphere, and reacted for 24 to 48 hours. The reaction was stopped, filtered by suction under vacuum, and washed sequentially with toluene, dichloromethane, tetrahydrofuran, acetone, methanol-water (1:1, v/v) and methanol.

The above-mentioned bonded silica gel was placed in a reactor, and a solution of 0.1% trifluoroacetic acid in methanol/water (5:1, v/v, 100 mL) was added. The mixture was reacted at room temperature for 16 to 24 hours. The reaction was stopped, filtered by suction under vacuum, and washed sequentially with acetone, methanol-water (1:1, v/v) and methanol, and dried at 80° C. for 24 hours.

The above-mentioned bonded silica gel was placed in a reactor, and xylene (100 mL) and excess by 50% molar of an endcapping reagent were added. The mixture was mechanically stirred and heated to reflux under argon atmosphere, and reacted for 16 to 48 hours. The reaction was stopped, filtered by suction under vacuum, washed sequentially with toluene, dichloromethane, tetrahydrofuran, acetone, methanol-water (1:1, v/v) and methanol, and dried at 80° C. for 24 hours. The polar chromatographic stationary phase was thus obtained.

In Examples 8 to 12, various bisamide-containing polar chromatographic stationary phases were synthesized by employing different polar silanes having two amide linkages and endcapping reagents and employing the same reaction conditions and treating methods as Example 7 (Table 2).

TABLE 2
The bisamide-containing polar chromatographic stationary phases in
Examples 8 to 12

| Stationary | | |
|---|---|---|
| phases | Silanes | Endcapping reagents |
| 1 | 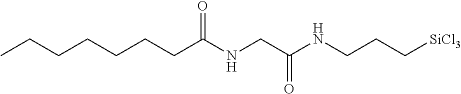 Heptacarbon dipeptidyl trichlorosilane | Mixture of trimethylchlorosilane and N-(trimethylsilyl) acetamide |
| 2 | 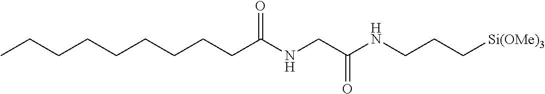 Nonacarbon dipeptidyl trimethoxysilane | (N,N-Dimethylamino) trimethylsilane |
| 3 | 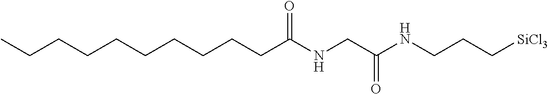 Decacarbon dipeptidyl trichlorosilane | Mixture of N-(trimethylsilyl) imidazole and hexamethyldisilazane |
| 4 | 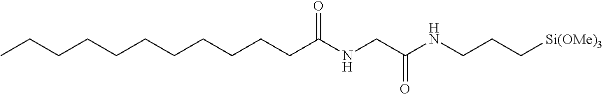 Undecacarbon dipeptidyl trimethoxysilane | Hexamethyldisilazane |
| 5 | 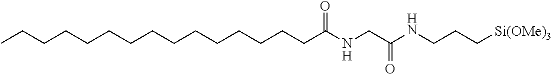 Pentadecacarbon dipeptidyl trimethoxysilane | Mixture of (N,N-dimethylamino) trimethylsilane and hexamethyldisilazane |

### Example 8

The silane is heptacarbon dipeptidyl trichlorosilane, the endcapping reagent is a mixture of trimethylchlorosilane trimethylsilyl chloride and N-(trimethylsilyl)acetamide. Polar chromatographic stationary phase 1: Elemental analysis: C % 14.05, H % 2.25, N % 2.52. Phase density: 3.3 μmol m⁻².

### Example 9

The silane is nonacarbon dipeptidyl trimethoxysilane, the endcapping reagent is (N,N-dimethylamino)trimethylsilane. Polar chromatographic stationary phase 2: Elemental analysis: C % 21.68, H % 3.81, N % 2.81. Phase density: 3.4 μmol m⁻².

### Example 10

The silane is decacarbon dipeptidyl trichlorosilane, the endcapping reagent is a mixture of N-(trimethylsilyl)imidazole and hexamethyldisilazane. Polar chromatographic stationary phase 3: Elemental analysis: C % 17.16, H % 2.77, N % 2.50. Phase density: 3.4 μmol m⁻². If the silane is decacarbon dipeptidyl trimethoxysilane, the endcapping reagent is hexamethyldisilazane, the elemental analysis of the obtained polar chromatographic stationary phase: C % 21.49, H % 3.62, N % 2.64. Phase density: 3.6 μmol m⁻².

### Example 11

The silane is undecacarbon dipeptidyl trimethoxysilane, the endcapping reagent is hexamethyldisilazane. Polar chromatographic stationary phase 4: Elemental analysis: C % 21.49, H % 3.76, N % 2.51. Phase density: 3.4 μmol m⁻².

### Example 12

The silane is pentadecacarbon dipeptidyl trimethoxysilane, the endcapping reagent is a mixture of (N,N-dimethylamino)trimethylsilane and hexamethyldisilazane. Polar chromatographic stationary phase 5: Elemental analysis: C % 24.78, H % 4.31, N % 2.41. Phase density: 3.5 μmol m⁻².

### Example 13

### Performance Evaluation of Chromatographic Columns

### 13.1 Packing of Analytical Columns

The bonded phase prepared in Examples 8 to 12 of the present application was packed into two individual 150 mm length×4.6 mm I.D. stainless steel columns via the slurry packing method with a packing pressure of 40 to 80 MPa for evaluation of the chromatographic performance.

### 13.2 Engelhardt Test

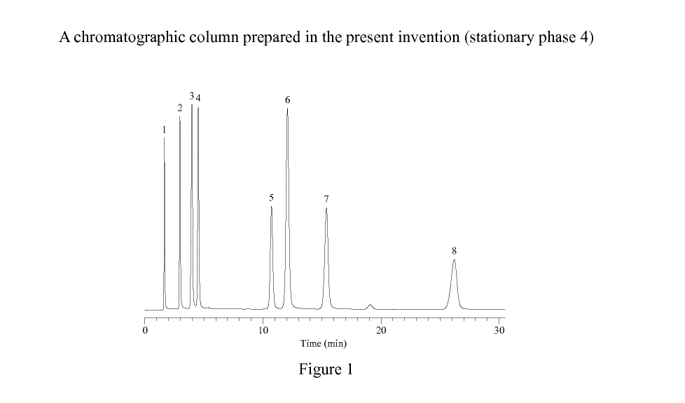

The chromatographic column prepared in Example 13.1 (the bonded phase is the polar chromatographic stationary phase 4 prepared in Example 11) was used to separate a mixture of 1 thiourea, 2 aniline, 3 phenol, 4 o-,m-,p-toluidine, 5 N,N-dimethylaniline, 6 ethyl benzoate, 7 toluene, and 8 ethylbenzene. FIG. 1 shows the chromatogram. The chromatographic conditions were as follows: mobile phase, methanol:water=55:45 (v/v); flow rate, 1 mL/min; column temperature, 25° C.; detection wavelength, UV254 nm.

### 13.3 Stability Test

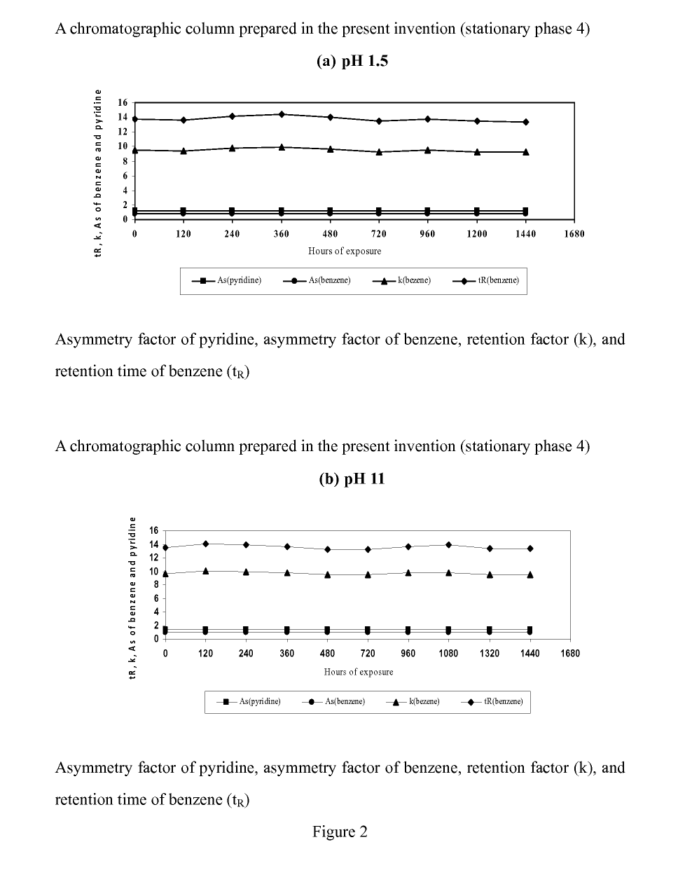

The chromatographic column prepared in Example 13.1 (the bonded phase is the polar chromatographic stationary phase 4 prepared in Example 11) was used to determine the stability of the chromatographic column of the present invention at different pH (FIG. 2). The elution condition for acidic mobile phase was: acetonitrile: 1% trifluoroacetic acid (pH 1.5, 1:1, v/v); the elution condition for alkaline mobile phase was: acetonitrile:20 mM phosphate buffer (pH 11, 1:1, v/v). The chromatographic conditions were as follows: mobile phase, acetonitrile:20 mM phosphate buffer (pH 7)=60:40 (v/v); flow rate, 1 mL/min; column temperature, 25° C.; detection wavelength, UV 254 nm. Samples, 1 uracil, 2 pyridine, 3 phenol, and 4 benzene.

### 13.4 Reproducibility Test

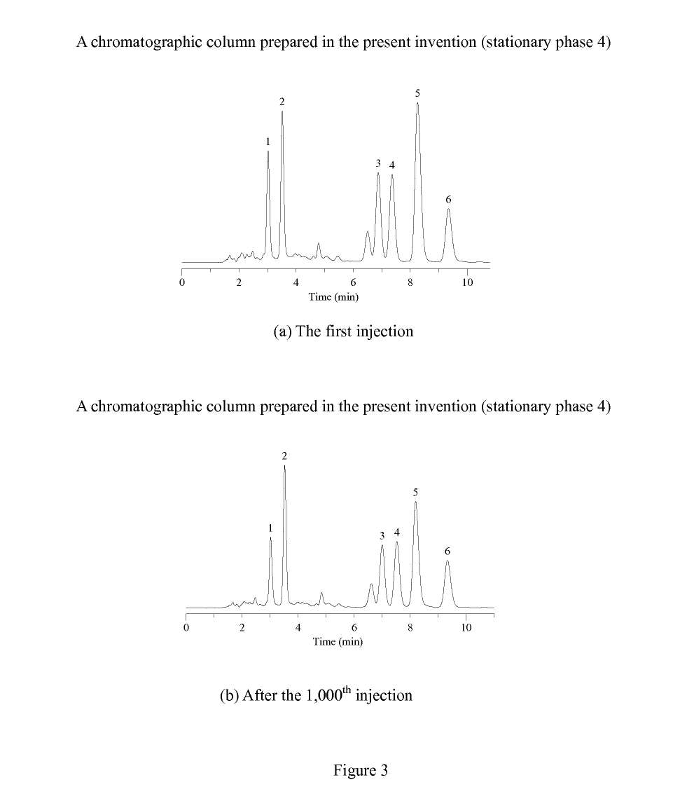

The chromatographic column prepared in Example 13.1 (the bonded phase is the polar chromatographic stationary phase 4 prepared in Example 11) was used to separate a mixture of 1 ceftazidime, 2 cefadroxil, 3 cefuroxime axetil, 4 cefazolin, 5 cefaclor and 6 cefalexin. FIG. 3 shows the chromatograms. The chromatographic conditions were as follows: mobile phase, methanol:0.1% trifluoroacetic acid in water=30:70 (v/v); flow rate, 1 mL/min; column temperature, 25° C.; detection wavelength, UV 230 nm.

### Example 14

### Separation of β-Blockers

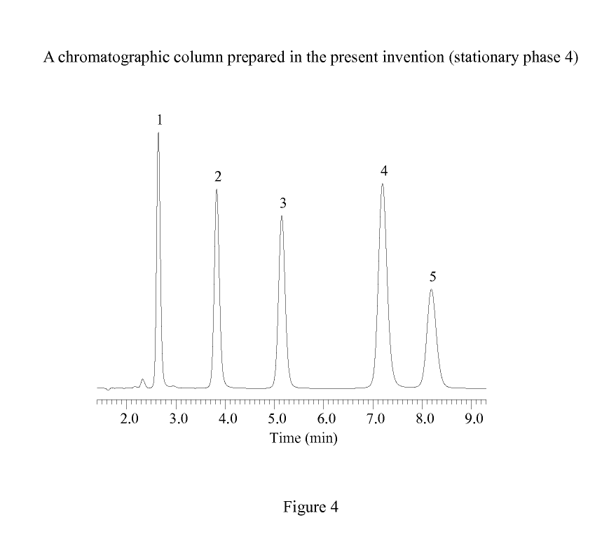

The chromatographic column prepared in Example 13.1 (the bonded phase is the polar chromatographic stationary phase 4 prepared in Example 11) was used to separate a mixture of 1 pindolol, 2 metoprolol, 3 bisoprolol, 4 propranolol and 5 alprenolol. FIG. 4 shows the chromatogram. The chromatographic conditions were as follows: mobile phase, methanol:5 mM ammonium bicarbonate aqueous solution (pH 10)=70:30 (v/v); flow rate, 1 mL/min; column temperature, 25° C.; detection wavelength, UV 220 nm.

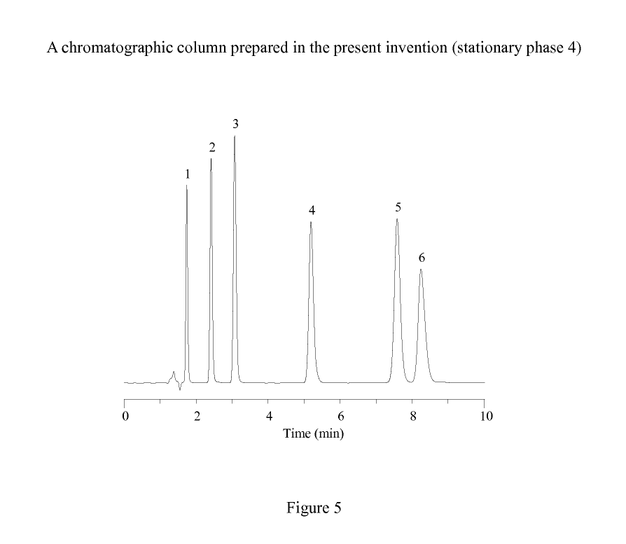

The chromatographic column prepared in Example 13.1 (the bonded phase is the polar chromatographic stationary phase 4 prepared in Example 11) was used to separate a mixture of 1 nadolol, 2 pindolol, 3 metoprolol, 4 labetalol, 5 propranolol and 6 alprenolol. FIG. 5 shows the chromatogram. The chromatographic conditions were as follows: mobile phase, 0.1% trifluoroacetic acid in acetonitrile:0.1% trifluoroacetic acid in water=30:70 (v/v); flow rate, 1 mL/min; column temperature, 25° C.; detection wavelength, UV 220 nm.

### Example 15

### Separation of Caffeine Metabolite Isomers

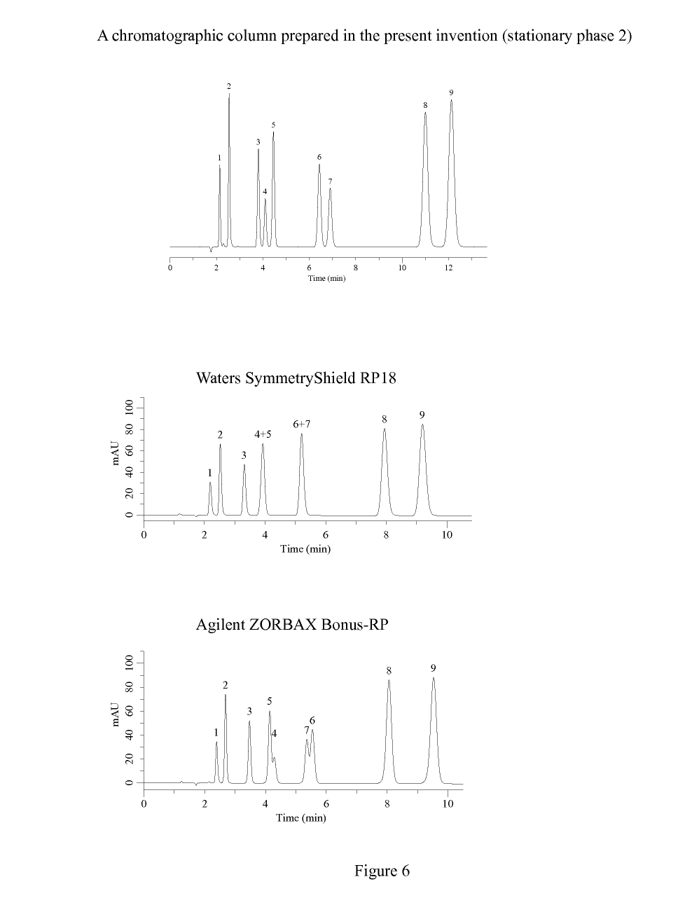

The chromatographic column prepared in Example 13.1 (the bonded phase is the polar chromatographic stationary phase 2 prepared in Example 9), Waters SymmetryShield RP18 column and Agilent Zorbax Bonus-RP column were used to separate a mixture of 1 uric acid, 2 xanthine, 3 7-methyl xanthine, 4 1-methyl uric acid, 5 3-methyl xanthine, 6 1,3-dimethyl uric acid, 7 theobromine, 8 1,7-dimethyl xanthine and 9 theophylline. FIG. 6 shows the chromatograms. The chromatographic conditions were as follows: mobile phase, methanol:1% acetic acid in water=10:90 (v/v); flow rate, 1 mL/min; column temperature, 25° C.; detection wavelength, UV 254 nm.

### Example 16

### Separation of Tocopherol Isomers

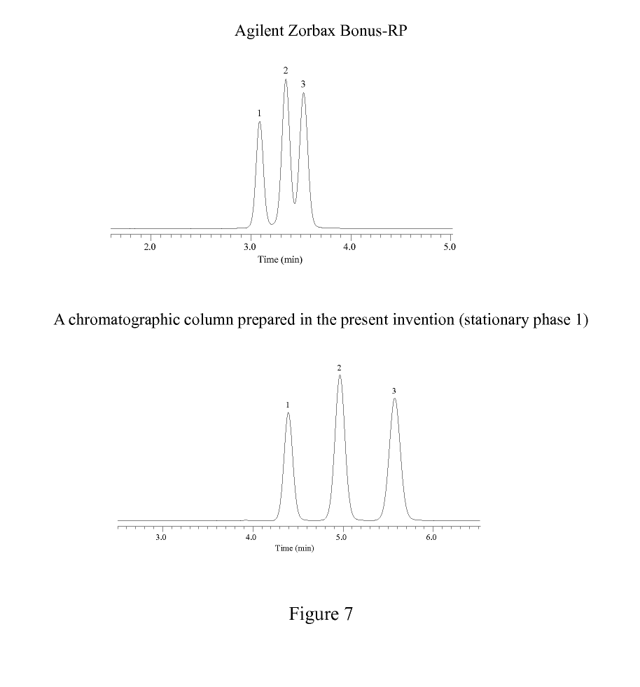

The chromatographic column prepared in Example 13.1 (the bonded phase is the polar chromatographic stationary phase 1 prepared in Example 8) and Agilent Zorbax Bonus-RP column were used to separate a mixture of 1 δ-tocopherol, 2 γ-tocopherol, and 3 α-tocopherol. FIG. 7 shows the chromatograms. The chromatographic conditions were as follows: mobile phase, methanol; flow rate, 1 mL/min; column temperature, 25° C.; detection wavelength, UV 295 nm.

### Example 17

### Separation of Water Soluble Vitamins

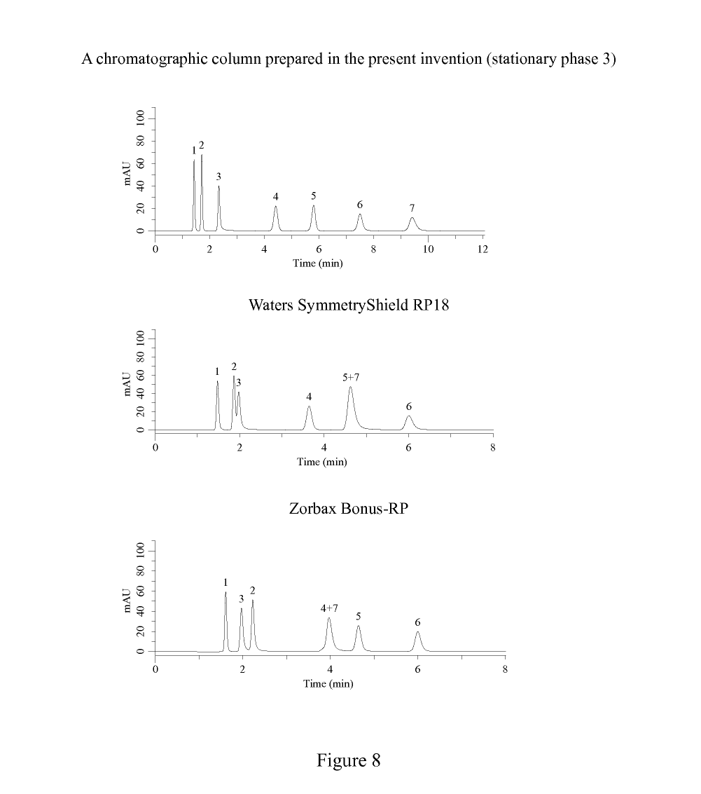

The chromatographic column prepared in Example 13.1 (the bonded phase is the polar chromatographic stationary phase 3 prepared in Example 10), Waters SymmetryShield RP18 column and Agilent Zorbax Bonus-RP column were used to separate a mixture of 1 L-ascorbic acid, 2 orotic acid, 3 pyridoxamine, 4 pyridoxal, 5 pyridoxine, 6 nicotinamide and 7 thiamine FIG. 8 shows the chromatograms. The chromatographic conditions were as follows: mobile phase, methanol:10 mM phosphate buffer (pH 7)=3:97 (v/v); flow rate, 1 mL/min; column temperature, 25° C.; detection wavelength, UV 254 nm.

### Example 18

### Separation of Nucleotides

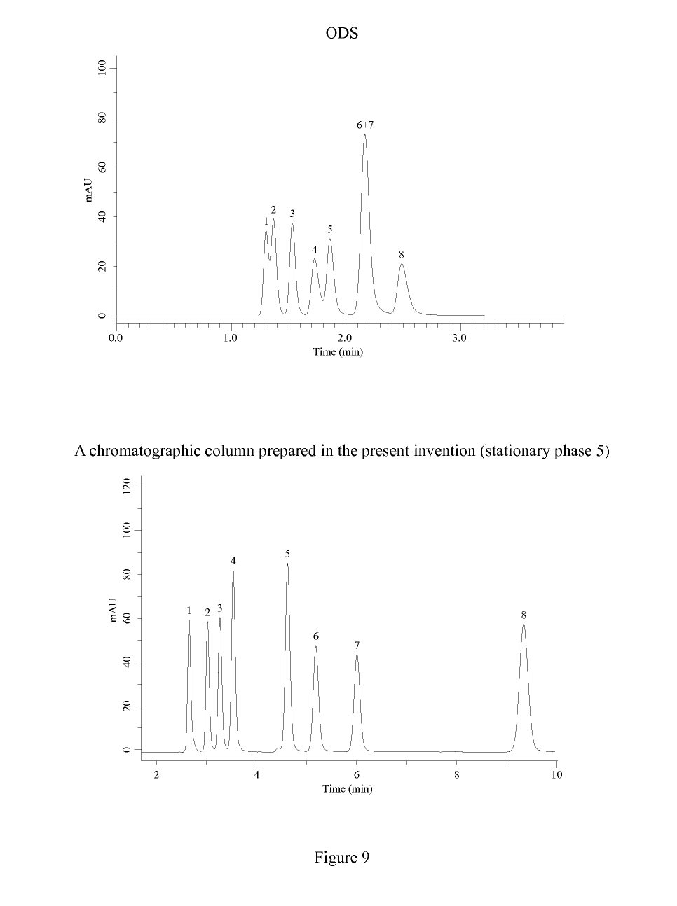

ODS column and the chromatographic column prepared in Example 13.1 (the bonded phase is the polar chromatographic stationary phase 5 prepared in Example 12) were used to separate a mixture of 1 CTP, 2 CMP, 3 GTP, 4 GDP, 5 GMP, 6 ATP, 7 ADP, and 8 AMP. FIG. 9 shows the chromatograms. The chromatographic conditions were as follows: mobile phase, 50 mM K₂HPO₄, pH 6.0; flow rate, 0.7 mL/min; column temperature, 25° C.; detection wavelength, UV 260 nm.

### Example 19

### Separation of a Mixture of Tricyclic Antidepressants and Benzodiazepines

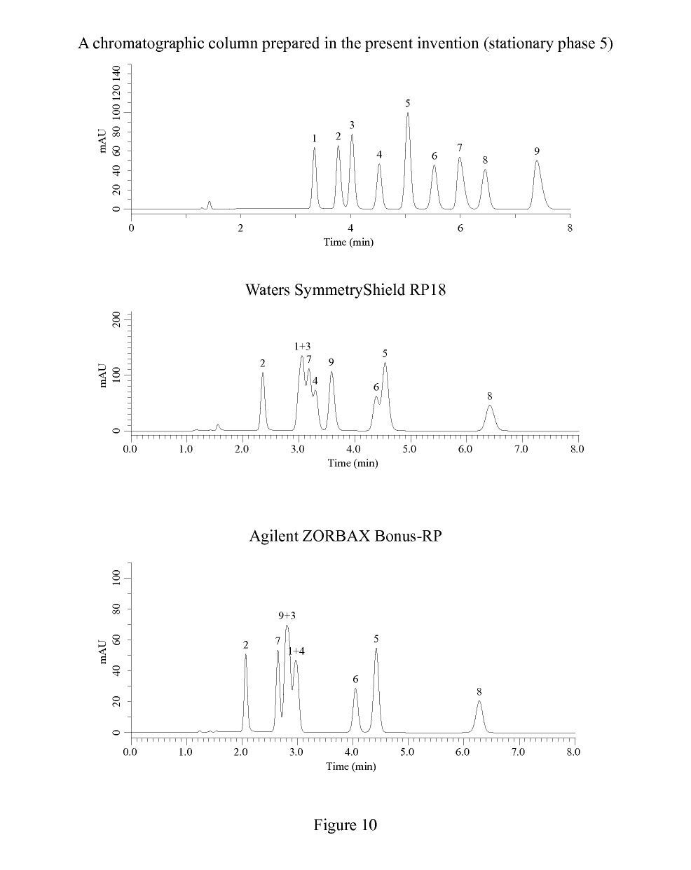

The chromatographic column prepared in Example 13.1 of the present application (the bonded phase is the polar chromatographic stationary phase 5 prepared in Example 12), Waters SymmetryShield RP18 column and Agilent Zorbax Bonus-RP column were used to separate a mixture of 1 nitrazepam, 2 nordoxepin, 3 alprazolam, 4 diazepam, 5 oxazepam, 6 triazolam, 7 nortriptyline, 8 clonazepam and 9 trimipramine FIG. 10 shows the chromatograms. The chromatographic conditions were as follows: mobile phase, 0.1% trifluoroacetic acid in acetonitrile:0.1% trifluoroacetic acid in water, 40:60 (v/v); flow rate, 1.0 mL/min; column temperature, 25° C.; detection wavelength, UV 254 nm.

What is claimed is:

1. A bisamide-containing liquid chromatographic media, wherein the media comprise a silica gel substrate that is modified with at least one polar silane having two amide linkages and further modified with an endcapping reagent, and have a general formula of 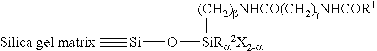
wherein R¹ is substituted or unsubstituted C₁-C₂₀ alkyl, phenyl, aralkyl, cycloalkyl, or heterocycloalkyl;
R² is substituted or unsubstituted C₁-C₈ alkyl, phenyl, aralkyl, cycloalkyl, or heterocycloalkyl;
α is 0 or 1;
β is an integral of 1 to 10;
γ is an integer of 1 to 20; and
X is halogen, alkoxy, acyloxy, or amino.

2. The liquid chromatographic media of claim 1, wherein the silica gel substrate is a spherical porous silica gel with a particle size of 1 μm to 60 μm, a pore size of 50 Å to 1000 Å, and a specific surface area of 50 m²/g to 500 m²/g.

3. The liquid chromatographic media of claim 1, wherein the polar silane having two amide linkages has the general formula of
R¹CONH(CH₂)_{γ}CONH(CH₂)_{β}SiR²_{α}X_{3-α}
wherein R¹ is substituted or unsubstituted C₁-C₂₀ alkyl, phenyl, aralkyl, cycloalkyl, or heterocycloalkyl;
R² is substituted or unsubstituted C₁-C₈ alkyl, phenyl, aralkyl, cycloalkyl, or heterocycloalkyl;
α is 0, 1, or 2;
β is an integral of 1 to 10;
γ is an integer of 1 to 20; and
X is halogen, alkoxy, acyloxy, or amino.

4. The liquid chromatographic media of claim 1, wherein the endcapping reagent is one or more selected from the group consisting of monosilane, disilane, trisilane, tetrasilane, and pentasilane.

5. The liquid chromatographic media of claim 4, wherein the monosilane includes trimethylchlorosilane, (N,N-dimethylamino)trimethylsilane, N-(trimethylsilyl)imidazole, methyltrichlorosilane, dimethyldichlorosilane, dimethoxydimethylsilane, trimethylsilanol, and N-(trimethylsilyl)acetamide.

6. The liquid chromatographic media of claim 4, wherein the disilane includes hexamethyldisilazane and 1,3-dimethoxytetramethyldisiloxane.

7. The liquid chromatographic media of claim 4, wherein the trisilane includes hexamethylcyclotrisiloxane.

8. The liquid chromatographic media of claim 4, wherein the tetrasilane includes octamethylcyclotetrasiloxane.

9. The liquid chromatographic media of claim 4, wherein the pentasilane includes decamethylcyclopentasiloxane.

10. A method of preparing a bisamide-containing liquid chromatographic media, the method comprising:
(a) modifying the surface of a silica gel substrate with a polar silane having two amide linkages;
(b) hydrolyzing and drying the thus-obtained materials; and
(c) further reacting the above prepared dry silica gel media with an endcapping reagent.

11. The method of claim 10, wherein the silica gel substrate is a spherical porous silica gel with a particle size of 1 μm to 60 μm, a pore size of 50 Å to 1000 Å, and a specific surface area of 50 m²/g to 500 m²/g.

12. The method of claim 10, wherein the polar silane having two amide linkages has the general formula of
R¹CONH(CH₂)_{γ}CONH(CH₂)_{β}SiR²_{α}X_{3-α}
wherein R¹ is substituted or unsubstituted C₁-C₂₀ alkyl, phenyl, aralkyl, cycloalkyl, or heterocycloalkyl;
R² is substituted or unsubstituted C₁-C₈ alkyl, phenyl, aralkyl, cycloalkyl, or heterocycloalkyl;
α is 0, 1, or 2;
β is an integer of 1 to 10;
γ is an integer of 1 to 20; and
X is halogen, alkoxy, acyloxy, or amino.

13. The method of claim 10, wherein the endcapping reagent is one or more selected from the group consisting of monosilane, disilane, trisilane, tetrasilane, and pentasilane.

14. The method of claim 13, wherein the monosilane includes trimethylchlorosilane, (N,N-dimethylamino)trimethylsilane, N-(trimethylsilyl)imidazole, methyltrichlorosilane, dimethyldichlorosilane, dimethoxydimethylsilane, trimethylsilanol, and N-(trimethylsilyl)acetamide.

15. The method of claim 13, wherein the disilane includes hexamethyldisilazane and 1,3-dimethoxytetramethyldisiloxane.

16. The preparation method of claim 13, wherein the trisilane includes hexamethylcyclotrisiloxane.

17. The preparation method of claim 13, wherein the tetrasilane includes octamethylcyclotetrasiloxane.

18. The preparation method of claim 13, wherein the pentasilane includes decamethylcyclopentasiloxane.

19. A chromatographic column packed with the bisamide-containing liquid chromatographic media of claim 1.

20. The liquid chromatographic media of claim 1, characterized in that, under an acidic or basic condition, relative standard deviations of retention time, retention factor and peak asymmetry of analytes separated on said stationary phase are all less than 5% even when exposed to acidic or basic elution conditions for 1440 hours.
